(19) United States
(12) Patent Application Publication
(10) Pub. No.: US 2026/0211783 A1
(43) Pub. Date: Jul. 23, 2026

(54) TECHNIQUES FOR DISASTER RECOVERY FOR CLOUD COMPUTING INFRASTRUCTURE AND CONFIGURATION UTILIZING INFRASTRUCTURE AS CODE

(71) Applicant: Go Firefly Ltd., Tel Aviv (IL)

(72) Inventors: Sefi GENIS, Ramat Gan (IL); Ido NEEMAN, Tel Aviv (IL)

(73) Assignee: Go Firefly Ltd., Tel Aviv (IL)

(21) Appl. No.: 19/033,016

(22) Filed: Jan. 21, 2025

(51) Int. Cl. G06F 11/14

(52) U.S. Cl. CPC G06F 11/2028; G06F 2009/45562

(57) ABSTRACT

A system and method for disaster recovery of a cloud computing environment utilizing infrastructure as code (IaC) is presented. The method includes accessing a primary cloud computing environment to detect resources deployed therein; extracting configuration data from each detected resource; generating a plurality of code objects, each code object based on extracted configuration data of a detected resource; generating a declaration code for an Infrastructure as Code (IaC) based at least on the generated plurality of code objects; receiving a request to initiate disaster recovery of the primary cloud computing environment; and deploying a plurality of resources in a secondary cloud computing environment based on the generated declaration code, in response to authenticating the request to initiate disaster recovery.

### TECHNICAL FIELD

The present disclosure relates generally to the field of cloud computing disaster recovery, and more specifically to performing disaster recovery of a computing environment utilizing IaC.

### BACKGROUND

Disaster recovery (DR) for cloud computing involves strategies and processes to restore data, applications, and IT infrastructure after a disruptive event such as natural disasters, cyberattacks, or system failures. In cloud environments, DR typically leverages the inherent flexibility and scalability of cloud platforms to ensure continuity and minimize downtime. This often includes data replication, backup services, and automated failover mechanisms across multiple geographic regions or cloud providers.

One critical challenge in cloud disaster recovery is achieving a balance between cost and recovery objectives. Organizations must decide on recovery point objectives (RPO) and recovery time objectives (RTO) that align with their operational priorities while managing the expenses of maintaining redundant resources and infrastructure. These decisions can be complex, particularly in environments with dynamic workloads and evolving business needs.

It would therefore be advantageous to provide a solution that would overcome the challenges noted above.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include accessing a primary cloud computing environment to detect resources deployed therein. The method may also include extracting configuration data from each detected resource. The method may furthermore include generating a plurality of code objects, each code object based on extracted configuration data of a detected resource. The method may in addition include generating a declaration code for an Infrastructure as Code (IaC) based at least on the generated plurality of code objects. The method may moreover include receiving a request to initiate disaster recovery of the primary cloud computing environment. The method may also include deploying a plurality of resources in a secondary cloud computing environment based on the generated declaration code, in response to authenticating the request to initiate disaster recovery. Other embodiments of this aspect include corresponding computer systems, apparatus, and computer programs recorded on one or more computer storage devices, each configured to perform the actions of the methods.

Implementations may include one or more of the following features. The method may include: accessing a plurality of sub-environments of the primary cloud computing environment; and generating for each sub-environment a declaration code based at least on code objects generated on resources of the sub-environment. The method may include: generating a plurality of declaration codes, each declaration code associated with a restoration point including code objects generated at a defined point in time. The method may include: accessing a second plurality of code objects located in a code repository; generating the declaration code based further on the second plurality of code objects, where the second plurality of code objects are integrated into the declaration code and located in an IaC configuration file. The method may include: detecting a resource deployed in the secondary cloud computing environment; and deprovisioning a corresponding resource in the primary cloud computing environment in response to detecting the deployed resource in the secondary cloud computing environment. The method where the code object from which the resource is deployed in the secondary cloud computing environment is generated based on configuration data extracted from the corresponding resource in the primary cloud computing environment. The method may include: storing the generated declaration code with an associated recovery point identifier. Implementations of the described techniques may include hardware, a method or process, or a computer tangible medium.

In one general aspect, a non-transitory computer-readable medium may include one or more instructions that, when executed by one or more processing circuitries of a device, cause the device to: access a primary cloud computing environment to detect resources deployed therein; extract configuration data from each detected resource; generate a plurality of code objects, each code object based on extracted configuration data of a detected resource; generate a declaration code for an Infrastructure as Code (IaC) based at least on the generated plurality of code objects; receive a request to initiate disaster recovery of the primary cloud computing environment; and deploy a plurality of resources in a secondary cloud computing environment based on the generated declaration code, in response to authenticating the request to initiate disaster recovery. Other embodiments of this aspect include corresponding computer systems, apparatus, and computer programs recorded on one or more computer storage devices, each configured to perform the actions of the methods.

In one general aspect, a system may include one or more processing circuitries configured to: access a primary cloud computing environment to detect resources deployed therein; extract configuration data from each detected resource; generate a plurality of code objects, each code object based on extracted configuration data of a detected resource; generate a declaration code for an Infrastructure as Code (IaC) based at least on the generated plurality of code objects; receive a request to initiate disaster recovery of the primary cloud computing environment; and deploy a plurality of resources in a secondary cloud computing environment based on the generated declaration code, in response to authenticating the request to initiate disaster recovery. Other embodiments of this aspect include corresponding computer systems, apparatus, and computer programs recorded on one or more computer storage devices, each configured to perform the actions of the methods.

Implementations may include one or more of the following features. The system where the one or more processing circuitries are further configured to: access a plurality of sub-environments of the primary cloud computing environment; and generate for each sub-environment a declaration code based at least on code objects generated on resources of the sub-environment. The system where the one or more processing circuitries are further configured to: generate a plurality of declaration codes, each declaration code associated with a restoration point including code objects generated at a defined point in time. The system where the one or more processing circuitries are further configured to: access a second plurality of code objects located in a code repository; and generate the declaration code based further on the second plurality of code objects, where the second plurality of code objects are integrated into the declaration code and located in an IaC configuration file. The system where the one or more processing circuitries are further configured to: detect a resource deployed in the secondary cloud computing environment; and deprovision a corresponding resource in the primary cloud computing environment in response to detecting the deployed resource in the secondary cloud computing environment. The system where the code object from which the resource is deployed in the secondary cloud computing environment is generated based on configuration data extracted from the corresponding resource in the primary cloud computing environment. The system where the one or more processing circuitries are further configured to: store the generated declaration code with an associated recovery point identifier; and store the generated declaration code with an associated recovery point identifier. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic diagram of a codifier in a cloud computing environment, implemented in accordance with an embodiment.

FIG. 2 is an example flowchart illustrating a method for generating a code object, according to an embodiment.

FIG. 3 is an example illustration of configuration properties of a detected resource, implemented in accordance with an embodiment.

FIG. 4 is an example illustration of a code object generated by the codifier, implemented in accordance with an embodiment.

FIG. 5 is an example flowchart for deploying resources based on declaratory code in a cloud computing environment, implemented in accordance with an embodiment.

FIG. 6 is an example flowchart of a method for performing disaster recovery of a cloud computing environment, implemented in accordance with an embodiment.

FIG. 7 is an example schematic diagram of a codifier according to an embodiment.

### DETAILED DESCRIPTION

The various disclosed embodiments include methods and systems for generating code objects based on detected configuration properties of deployed cloud resources in a cloud infrastructure. According to the disclosed embodiments, a code object is generated based on the detected configuration information of a unique resource deployed in a cloud computing environment.

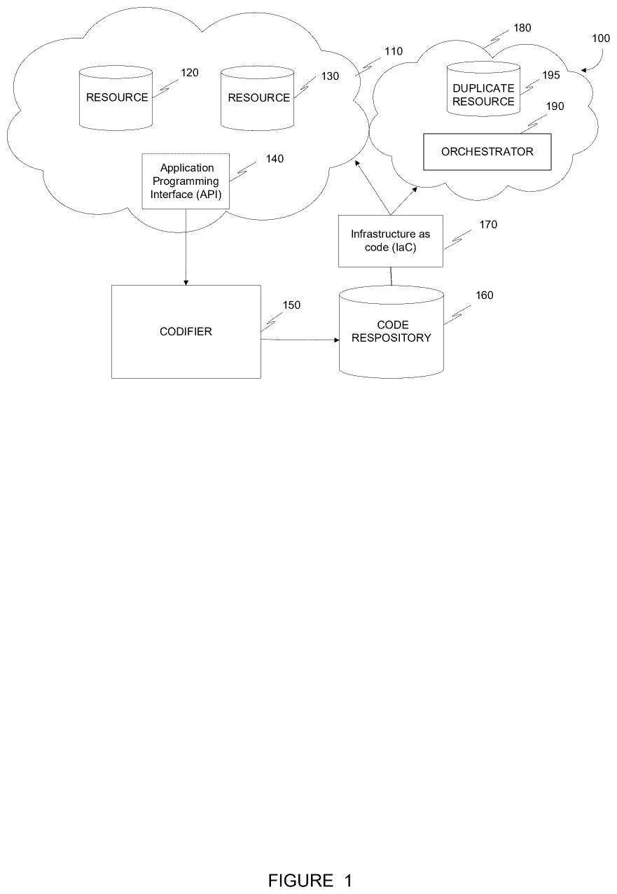

FIG. 1 is an example schematic diagram 100 of a codifier in a cloud computing environment, implemented in accordance with an embodiment. In an embodiment, the first cloud computing environment 110, includes a plurality of resources, such as a first resource 120, a second resource 130, and an Application Programming Interface (API) 140. In an embodiment, the first cloud computing environment 110 is communicative with a codifier 150, and an Infrastructure as Code (IaC) 170. In an embodiment, the codifier 150 is communicatively coupled with a code repository 160 and a second cloud computing environment 180. The second cloud computing environment 180 includes an orchestrator 190 and a single or a plurality of resources (e.g. a duplicate resource 195), in some embodiments.

In an embodiment, the first cloud computing environment 110 includes a virtual private cloud (VPC), Virtual Network (VNet), virtual private network (VPN) and the like. A cloud computing platform is implemented on a cloud computing infrastructure, for example, such as Amazon® Web Services (AWS), Google Cloud Platform® (GCP), Microsoft® Azure, and the like.

In an embodiment, the first cloud computing environment 110 includes a plurality of cloud entities deployed therein. According to an embodiment, a cloud entity is, for example, a principal, a resource, and the like. In an embodiment, a plurality of resources, such as a first resource 120, a second resource 130, a combination thereof, and the like, is deployed in the first cloud computing environment 110. In some embodiments, a first resource 120 and a second resource 130 are cloud entities that provide access to a compute resource, such as a processor, a memory, storage, and the like.

In some embodiments, a first resource 120 and a second resource 130, are virtual machines, software containers, serverless functions, and the like. According to certain embodiments, a first resource 120 and a second resource 130, include a software application deployed thereon, such as a webserver, a gateway, a load balancer, a web application firewall (WAF), an appliance, various combinations thereof, and the like.

In an embodiment, a cloud entity is a principal relative to another cloud entity and a first resource 120 to other cloud entities. In an embodiment, a cloud entity is a principal relative to another cloud entity and a second resource 130, to other cloud entities. For example, a load balancer is a first resource 120 to a user account requesting a webpage from a webserver behind the load balancer, and the load balancer is a principal to the webserver. In some embodiments, a first resource 120 and a second resource 130 are configured to communicate with each other via an internal bus, data bus, Local Area Network (LAN), inter-process communication (IPC), and the like.

In some embodiments, the first cloud computing environment 110 includes an Application Programming Interface (API) 140. In an embodiment, the API 140 is configured to enable two software components to communicate with each other using a set of definitions and protocols. In certain embodiments, the API 140 is utilized to access a first resource 120, a second resource 130, etc., of the first cloud computing environment 110. For example, in an embodiment, a first resource 120 is configured to generate an API call. In an embodiment, a process deployed on a virtual machine initiates an API call, for example to the API 140.

In an embodiment, the codifier 150 is configured to generate code objects. In some embodiments, the codifier 150 is configured to generate code objects based on configuration properties of detected resources. In an embodiment, the codifier 150 is configured to send requests, instructions, a combination thereof, and the like to the API 140 in a software language. For example, in an embodiment, the codifier 150 is configured to send a request to the API 140 requesting configuration information on deployed resources in the first cloud computing environment 110.

In certain embodiments, the API 140 is configured to convert the requests, commands, instructions, etc., from the codifier 150 into an internalized cloud system request. In various embodiments, the API 140 is configured to generate and return responses to the codifier's 150 requests, instructions, etc.

For example, in an embodiment, the API 140 is configured to send information on resources deployed in the first cloud computing environment 110 to the codifier 150 in response to the codifier 150 requesting information on the resources. For example, in an embodiment, the API 140 is configured to send information pertaining to deployed resources in the cloud computing environment, such as resource identification, data source, Infrastructure as Code (IaC) status, a location of the resource, properties of the resource, tags of the resource, a timestamp, a combination thereof, and the like.

In some embodiments, the codifier 150 is configured to generate a code object, for example utilizing a language model. In an embodiment, the codifier 150 is configured to generate a prompt for a language model utilizing retrieved information from the API 140, a prompt template, a combination thereof, and the like, to generate a prompt for generating a code object.

In various embodiments, the codifier 150 is configured to provide the generated prompt to a single language model, a plurality of language models, and the like. In some embodiments, the language model is a large language model (LLM), small language model (SLM), and the like.

In an embodiment, the language model is configured to output a codifying prompt based on the input prompt from the codifier 150. In some embodiments, the codifier 150 is configured to feed the specific prompt to a single language model, a plurality of language models, etc., to generate a response. In an embodiment, the codifier 150 is configured to utilize data of the generated response from the language model to generate a code object.

In various embodiments, the code object is based on configuration properties of a deployed resource, a plurality of deployed resources, etc., in the first cloud computing environment 110.

In an embodiment, a code repository 160 includes a version control systems (VCS) repository that stores metadata for a set of files and stores the history of changes made to those files. For example, in an embodiment, the VCS is deployed utilizing Github®. In some embodiments, the code repository 160 is configured to store any one of: code objects, declaration code, IaC configuration files, Terraform® configuration file, a combination thereof and the like. In certain embodiments, the code repository 160 is a cloud database which is deployed to run in a public or hybrid cloud environment and is managed by database-as-a-service (DBaaS) or deployed in a cloud-based virtual machine (VM).

According to some embodiments, the VCS includes code objects of an IaC platform, such as IaC platform 170. In an embodiment, an IaC code object is, for example, a Terraform® code object.

An IaC platform 170 is configured to eliminate the need to manually configure and manage cloud resources, by defining the desired state of cloud resources using code, in various embodiments. Such code (e.g. declaration code) is typically written in a declarative language, allowing to specify the desired configuration and relationships between various resources, in an embodiment. In some embodiments, IaC code is version-controlled, shared, and collaborated on using code repository tools.

In some embodiments, the IaC platform 170 is configured to define and manage infrastructure resources across different cloud providers using code, offering a unified approach to infrastructure management in multi-cloud or hybrid cloud environments. Some examples of an IaC platform 170 used in the cloud computing industry include Terraform®, AWS® CloudFormation, Azure® Resource Manager, and Google® Cloud Deployment Manager. In various embodiments, an IaC platform 170 is configured to retrieve code objects from the code repository 160 and deploy them as instances in a second cloud computing environment 180.

In an embodiment, a second cloud computing environment 180 is implemented as a virtual private cloud (VPC), Virtual Network (VNet), virtual private network (VPN) and the like. A second cloud computing environment 180 is implemented on a cloud computing infrastructure, for example, such as Amazon® Web Services (AWS), Google Cloud Platform® (GCP), Microsoft® Azure, and the like.

According to an embodiment, a second cloud computing environment 180 is implemented on the same cloud computing infrastructure as the first cloud computing environment 110. In an embodiment, the second cloud computing environment 180 is implemented on a second cloud computing infrastructure (e.g., AWS) and the first cloud computing environment is implemented on a first cloud computing infrastructure (e.g., Azure).

In some embodiments, the second cloud computing environment 180 includes the same VPC, the same VPN, the same VNet, a combination thereof, and the like, as the first cloud computing environment 110. In an embodiment, the second cloud computing environment 180 and the first cloud computing environment 110 each have a unique VPC, a unique VPN, a unique VNet, a combination thereof, and the like.

In an embodiment, the codifier 150 is configured to deploy a resource, a plurality of resources, etc. in a second cloud computing environment 180. In some embodiments, the codifier 150 is configured to access code objects stored in the code repository 160. In various embodiments, the codifier 150 is configured to integrate the code objects with declaration code and incorporate them into a Terraform® configuration file, an IaC configuration file, a combination thereof, and the like.

In various embodiments, such files (e.g., Terraform® configuration file, IaC configuration file, etc.) define the desired state and infrastructure of another cloud computing environment (e.g., second cloud computing environment 180) that is to be deployed.

Furthermore, such files (e.g., Terraform® configuration file, IaC configuration file) define resources that are to be deployed in another cloud computing environment (e.g. second cloud computing environment 180). In certain embodiments, code objects of the IaC configuration file provide data that defines resources, resource types, resource functions, resource locations, a combination thereof, and the like. In various embodiments, the codifier 150 is configured to trigger the deployment of a single resource, a plurality of resources, etc., in a second cloud computing environment 180.

In an embodiment, the codifier 150 is configured to trigger the deployment of a duplicate resource 195 of a plurality of resources in the second cloud computing environment 180. In certain embodiments, a duplicate resource 195 is identical in configuration to a resource located in the first cloud computing environment 110. In an embodiment, the duplicate resource 195 has an: identical resource type, identical resource function, identical resource deployment location, identical configuration, a combination thereof, and the like, to a resource located in the first cloud computing environment 110.

In various embodiments, the codifier 150 is configured to send a request to the orchestrator 190 to provision the deployed resources. In various embodiments, the orchestrator 190 is configured to provision the deployed resources (e.g. duplicate resource 195) in the second cloud computing environment 180 by allocating any one of: a virtual machine, storage, networks, processor, memory, virtual resource, physical resource, a combination thereof, and the like.

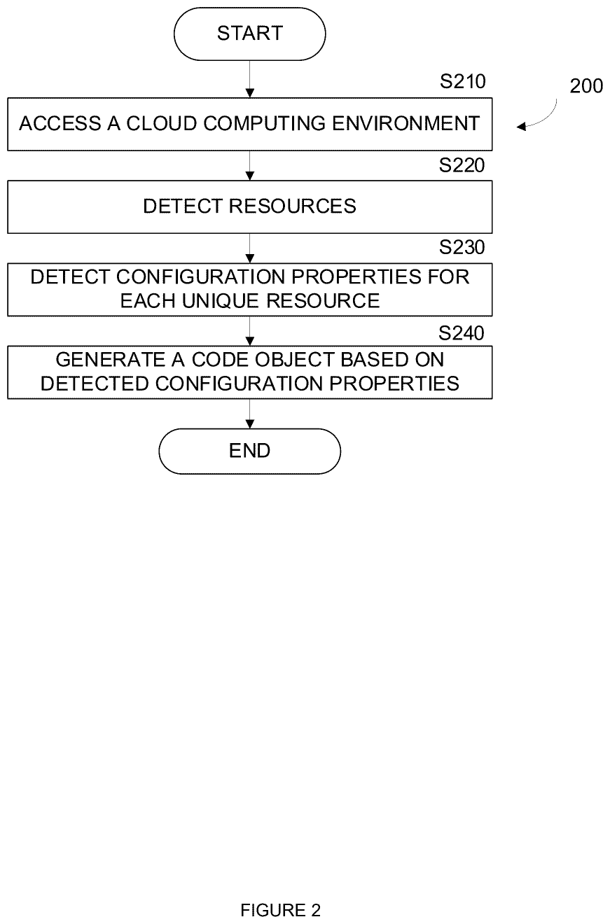

FIG. 2 is an example flowchart 200 illustrating a method for generating a code object, according to an embodiment.

At S210, a cloud computing environment is accessed. In an embodiment, a codifier (FIG. 1, 150) accesses a first cloud computing environment (FIG. 1, 110) including information about resources and configuration properties through an API (FIG. 1, 140). The codifier (FIG. 1, 150) is configured to obtain access to the first cloud computing environment (FIG. 1, 110) by sending requests (e.g. commands, instructions, etc.) to the API (FIG. 1, 140) seeking information about resources deployed in the first cloud computing environment (FIG. 1, 110).

At S220, resources are detected. In various embodiments, resources deployed in the first cloud computing environment (FIG. 1, 110) such as a first resource (FIG. 1, 120) and a second resource (FIG. 1, 130) are detected. The codifier (FIG. 1, 150) is configured to detect resources from the first cloud computing environment (FIG. 1, 110) by communicating with the API (FIG. 1, 140), according to an embodiment.

In an embodiment, the codifier (FIG. 1, 150) is configured to send requests (e.g. commands, instructions, etc.) to the API (FIG. 1, 140) seeking the identification of resources deployed in the first cloud computing environment (FIG. 1, 110). In certain embodiments, the API (FIG. 1, 140) is configured to convert the requests from the codifier (FIG. 1, 150) into a software language.

In an embodiment, the codifier (FIG. 1, 150) is configured to generate requests seeking configuration properties of deployed resources in the cloud computing environment (FIG. 1, 110). In various embodiments, the API (FIG. 1, 140) is configured to generate a response to a request from the codifier (FIG. 1, 150) including the identifying of resources deployed in the first cloud computing environment (FIG. 1, 110).

Further, in an embodiment, the API (FIG. 1, 140) is configured to generate responses to the codifier (FIG. 1, 150) identifying configuration properties of the deployed resources in the first cloud computing environment (FIG. 1, 110). In some embodiments, the codifier (FIG. 1, 150) is configured to collect, extract, parse, etc., data from the received responses from the API (FIG. 1, 140) and identify configuration parameters of resources detected in the first cloud computing environment (FIG. 1, 110).

At S230, configuration properties for each unique resource is detected. In some embodiments, where the codifier (FIG. 1, 150) detects resources in the first cloud computing environment (FIG. 1, 110), then the codifier (FIG. 1, 150) is configured to request configuration information (e.g. configuration properties) for a unique resource.

In various embodiments, a unique resource is a detected resource which has multiple instances deployed in the computing environment. For example, in an embodiment, an Amazon® auto-scaling group (ASG) includes a plurality of virtual machines, each virtual machine being an instance from a single image, code object, etc.

In certain embodiments, the API (FIG. 1, 140) is configured to send a response providing further data about the unique resource such as an identification of the resource, data source, IaC status, location of the resource, configuration properties, tags, timestamp, a combination thereof, and the like. In some embodiments, the codifier (FIG. 1, 150) is configured to retrieve and parse the configuration information generated from the API (FIG. 1, 140) to detect configuration properties for each unique resource.

At S240, a code object is generated. In an embodiment, the code object is generated based on detected configuration properties. In some embodiments, the code object is generated based on detected configuration properties for each unique resource. In an embodiment, the codifier (FIG. 1, 150) is configured to generate code objects.

In various embodiments, the codifier (FIG. 1, 150) is configured to utilize the retrieved configuration information, stored prompt templates, and the like to generate a generic prompt. In an embodiment, the generic prompt is a request, command, query, instruction, a combination thereof, and the like. In some embodiments, the generic prompt is provided to a language model to generate a specific prompt.

In certain embodiments, the specific prompt is a request, command, query, instruction, a combination thereof, and the like. The codifier (FIG. 1, 150) is configured to provide the specific prompt to language model, in an embodiment. In certain embodiments, the language model is configured to generate a response to the specific prompt from the codifier (FIG. 1, 150).

In various embodiments, the codifier (FIG. 1, 150) is configured to retrieve the response from the language model and utilize the language model response to generate a code object. In some embodiments, the code object is generated based on the generic prompt, specific prompt, and configuration properties of resources deployed in the cloud computing environment (FIG. 1, 110), a combination thereof, and the like.

In an embodiment, the code object includes configuration code of a specific IaC platform, such as Terraform®. In certain embodiments, the configuration code includes a plurality of code objects, each code object corresponding to a resource deployed in the computing environment accessed by the codifier.

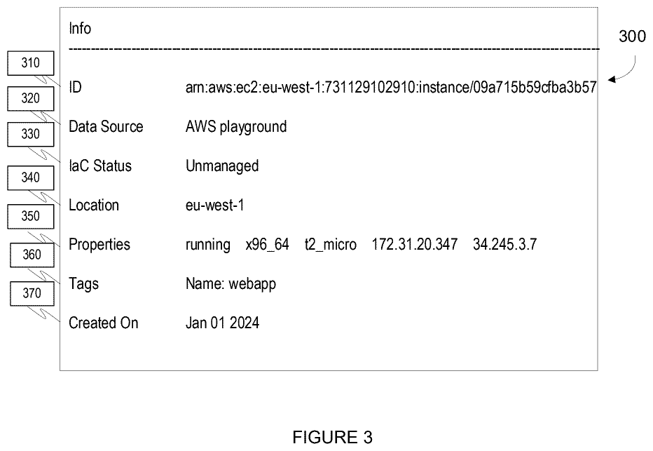

FIG. 3 is an example illustration 300 of configuration properties of a detected resource, implemented in accordance with an embodiment.

In some embodiments, the codifier (FIG. 1, 150) is configured to send requests, instructions, and the like, to the API (FIG. 1, 140) of a computing environment in order to receive configuration information pertaining to deployed resources in the cloud computing environment (FIG. 1, 110).

In various embodiments, the API (FIG. 1, 140) is configured to receive requests for configuration information for a unique resource from a codifier (FIG. 1, 150). In an embodiment, the API is configured to convert a received request into internalized cloud system requests. Furthermore, the API (FIG. 1, 140) is configured to generate a response to the codifier's request for configuration information, in certain embodiments.

For example, in an embodiment, the API (FIG. 1, 140) is configured to provide the codifier (FIG. 1, 150) with configuration data of a unique resource such as a unique identifier of the resource 310, data source of the resource 320, IaC status of the resource 330, location of the resource 340, configuration properties 350, tags 360, a creation date of the resource 370, a combination thereof, and the like.

In an embodiment, deployed resources in a cloud computing environment 110 are assigned a unique identifier 310 which is used to track and manage the resource. In some embodiments, the unique identifier 310 is a string that includes a unique combination of letters and numerals. Further, in an embodiment, the unique identifier 310 indicates the type of resource, the zone the resource is located in, the region the resource is located in, a combination thereof, and the like.

In an embodiment, resources in a cloud computing environment have a data source 320 that indicates the initial location where the resource originated. In other embodiments, the data source 320 is a service or tool provided by the cloud infrastructure provider. For example, in some embodiments, the data source 320 is Amazon® Web Services (AWS) Management Console, Azure® portal, Google® Cloud Console, Google® Cloud API, and the like.

In some embodiments, resources in cloud computing environments include an IaC status 330. In various embodiments, an IaC platform (FIG. 1, 170) is configured to define and manage cloud computing resources across different cloud providers using code. An IaC platform (FIG. 1, 170) offers a unified approach to infrastructure management in multi-cloud or hybrid cloud environments. Various embodiments of the IaC platform (FIG. 1, 170) used in the cloud computing industry include Terraform®, AWS® CloudFormation, Azure® Resource Manager, and Google® Cloud Deployment Manager.

In certain embodiments, an IaC status 330 indicates whether a resource in the cloud computing environment (FIG. 1, 110) is actively managed or controlled by an IaC platform (FIG. 1, 170).

In certain embodiments, the API (FIG. 1, 140) is configured to indicate locations 340 of resources in a cloud computing environment, which indicate the location at which the resource is deployed.

In various embodiments, resources in a cloud infrastructure have configuration properties 350. In some embodiments, configuration properties 350 define the structure of a deployment including the type and properties of the resources that are deployed in the cloud infrastructure. For example, in some embodiments, configuration properties 350 include any one of: an instance type, a key pair, a security group, user data, Identity and Access Management (IAM) role, an availability zone, any combination thereof, and the like.

In some embodiments, tags 360 are used to assign metadata to resources in the cloud infrastructure. In various embodiments, tags 360 are tools used to manage, identify, organize, search for, and filter resources in the cloud infrastructure.

In various embodiments, resources in a cloud infrastructure have a creation date 370 which indicates the date the resource was created. In certain embodiments, the creation date 370 is a timestamp that indicates the time the resource was created. In an embodiment, the creation date is a date of deployment of the resource, a date of creation of a code object from which the resource is deployed, and the like.

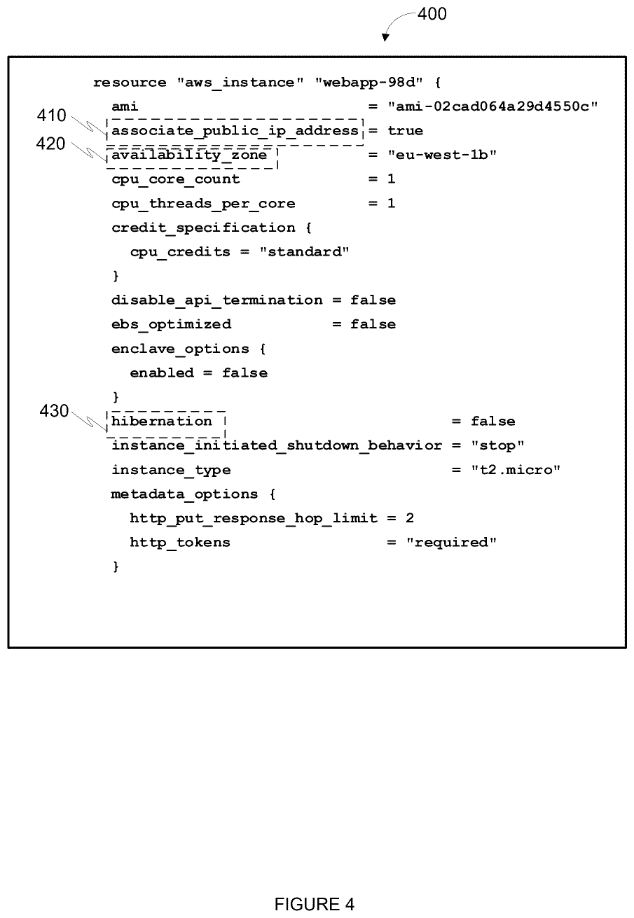

FIG. 4 is an example illustration of a code object 400 generated by the codifier, implemented in accordance with an embodiment.

Components of a cloud computing environment (FIG. 1, 110) are deployed, in an embodiment, utilizing an infrastructure as code platform, development tools, and the like, in a development (i.e., dev) environment, and deployed to a test environment where code is tested.

In various embodiments, a code object is a unit of code that can be deployed and run within a cloud infrastructure. The code object is generated by a codifier (FIG. 1, 150) based on configuration information of the deployed resources (e.g. unique resources) in the cloud infrastructure. For example, in an embodiment, code objects include configuration properties such as an internet protocol address 410, an availability zone 420, hibernation status 430, a combination thereof, and the like.

In an embodiment, the codifier (FIG. 1, 150) is configured to access the cloud computing environment (FIG. 1, 110) through the API (FIG. 1, 140). In some embodiments, the codifier (FIG. 1, 150) is configured to send requests, instructions, and the like, to the API (FIG. 1, 140) to detect configuration information pertaining to resources deployed in the cloud computing environment (FIG. 1, 110).

In an embodiment, the API (FIG. 1, 140) is configured to generate configuration information. In some embodiments the codifier (FIG. 1, 150) is configured to send a response to the codifier (FIG. 1, 150) identifying resources and providing configuration information about unique resources deployed in the cloud infrastructure. In some embodiments, the codifier (FIG. 1, 150) is configured to collect, extract, parse, etc., the generated response from the API (FIG. 1, 140).

In various embodiments, the codifier (FIG. 1, 150) is configured to utilize both the received configuration information response from the API (FIG. 1, 140) and a stored prompt template to generate a generic prompt.

In an embodiment, the generic prompt includes a request, command, query, instruction, a combination thereof, and the like. In some embodiments, the generic prompt is provided to an LLM to generate a specific prompt.

In certain embodiments, the specific prompt includes a request, command, query, instruction, a combination thereof, and the like. The codifier (FIG. 1, 150) is configured to provide the specific prompt to a language model, in an embodiment. In certain embodiments, the language model is configured to generate a response to the specific prompt from the codifier (FIG. 1, 150).

In various embodiments, the codifier (FIG. 1, 150) is configured to retrieve the response from the LLM and utilize the LLM response to generate a code object. In some embodiments, a code object is generated based on the generic prompt, specific prompt, configuration properties of unique resources deployed in the cloud computing environment (FIG. 1, 110), a combination thereof, and the like.

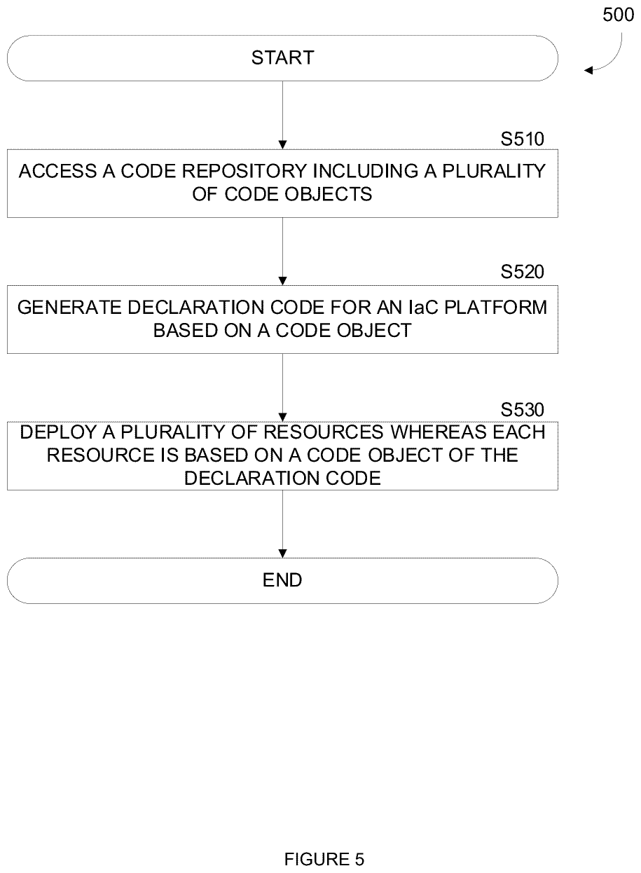

FIG. 5 in example flowchart 500 for deploying resources based on declaratory code in a cloud computing environment, implemented in accordance with an embodiment.

At S510, a code repository is accessed. In an embodiment, the code repository (FIG. 1, 160) including a plurality of code objects is accessed. In certain embodiments, a codifier (FIG. 1, 150) is configured to access the code repository (FIG. 1, 160) including code objects generated by the codifier (FIG. 1, 150) located in the code repository (FIG. 1, 160).

At S520, a declaration code is generated. In some embodiments, the declaration code is generated for an IaC platform. In an embodiment, the declaration code for the IaC platform (FIG. 1, 170) is generated based on a code object, a plurality of code objects, etc. In an embodiment, the codifier (FIG. 1, 150) is configured to generate declaration code based on the accessed code objects retrieved from the code repository (FIG. 1, 160).

In an embodiment, code objects from the code repository (FIG. 1, 160) are integrated into declaration code in an IaC configuration file, Terraform® configuration file, etc., a combination thereof, and the like.

In various embodiments, the Terraform® configuration file, the IaC configuration file a combination thereof, and the like, define the desired state of a cloud computing environment that is to be deployed. In an embodiment, the Terraform® configuration file, the IaC configuration file a combination thereof, and the like, define resources that are to be deployed in the cloud computing environment.

In some embodiments, the IaC configuration file (e.g. Terraform® configuration file) includes data on what types of resources should be deployed in the cloud computing environment including the function of each resource, the location of each resource within the cloud computing environment, a combination thereof, and the like.

In various embodiments, the codifier (FIG. 1, 150) is configured to send the generated declaration code located in the IaC configuration file (e.g. Terraform® configuration file) to the code repository (FIG. 1, 160) which stores the file. In some embodiments, the codifier is configured to provide access to an IaC platform to the declaration code.

At S530, a plurality of resources are deployed. In an embodiment, a plurality of resources are deployed wherein each resource is deployed based on a code object of the declaration code.

In some embodiments, the code objects that are integrated into the declaration code of the IaC configuration file (e.g. Terraform® configuration file) identify resources that should be deployed in a cloud computing environment. In certain embodiments, the code objects provide data that define resources, resource types, resource functions, resource locations in the cloud computing environment, a combination thereof, and the like. In various embodiments, the codifier (FIG. 1, 150) is configured to trigger the deployment of a resource, a plurality of resources, and the like, in a second cloud computing environment (FIG. 1, 180).

In an embodiment, the codifier (FIG. 1, 150) is configured to trigger the deployment of a duplicate resource (FIG. 1, 195) in the second cloud computing environment (FIG. 1, 180). In certain embodiments, a duplicate resource (FIG. 1, 195) is deployed in the second cloud computing environment (FIG. 1, 180) and includes an identical configuration to a first resource located in the first cloud computing environment (FIG. 1, 110).

In an embodiment, the duplicate resource (FIG. 1, 195) includes an identical resource type, function, deployment location, combination thereof, and the like, of a resource in the first cloud computing environment (FIG. 1, 110). In an embodiment, the codifier (FIG. 1, 150), an IaC platform, and the like, is configured to send a request to an orchestrator (FIG. 1, 190) to provision the deployed resources. In various embodiments, the orchestrator (FIG. 1, 190) is configured to provision the deployed resources (e.g. duplicate resource FIG. 1, 195) in the second cloud computing environment (FIG. 1, 180).

According to an embodiment, the codifier is configured to trigger the deployment of a resource in a second cloud computing environment by providing the declaration code to an IaC platform, and initiating a computer instruction (for example through an API) which causes the IaC platform to deploy a resource in a second cloud computing environment based on the declaration code.

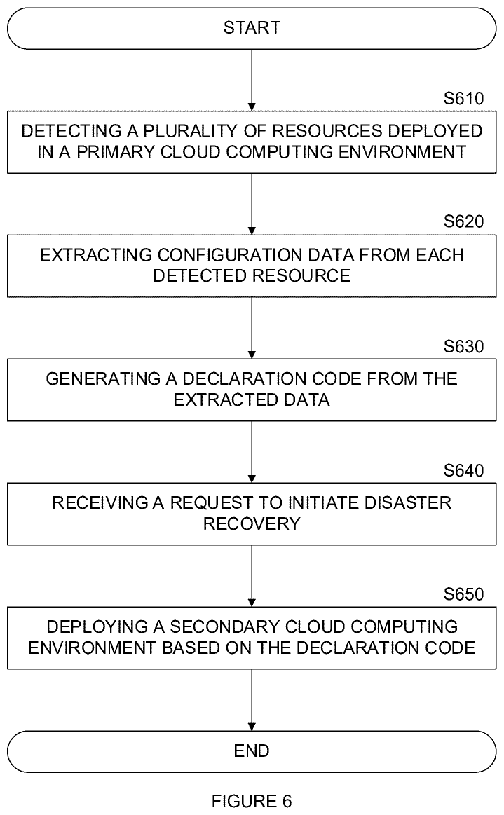

FIG. 6 is an example flowchart of a method for performing disaster recovery of a cloud computing environment, implemented in accordance with an embodiment. In some embodiments, a cloud computing environment requires recovery to a previous state. For example, this can occur due to a cyberattack, a misconfiguration, a malfunction, a break, and the like. In certain embodiments, a primary computing environment, such as the first cloud computing environment 110, includes a plurality of recovery points, each associated with a unique time point.

At S610, a plurality of resources are detected. In an embodiment, the plurality of resources are detected in a primary cloud computing environment. In some embodiments, a codifier is configured to detect resources in a primary cloud computing environment, for example by initiating network discovery, API querying, a combination thereof, and the like.

In an embodiment, a resource includes a virtual machine, a software container, a serverless function, a combination thereof, and the like. In some embodiments, a resource is associated with network attributes, such as an identifier of a VPC, VNet, VPN, subnet, IP address, a combination thereof, and the like.

In certain embodiments, the resource further includes a location, a property, a tag, a name, a domain, an identifier, a combination thereof, and the like. In some embodiments, certain resources include certain attributes, while other resources include other attributes.

At S620, configuration data is extracted. In an embodiment, configuration data is extracted from each detected resource, from a portion of detected resources, and the like. In some embodiments, the codifier is configured to request configuration information (e.g. configuration properties) for a resource, for example through an API of a cloud computing environment.

In various embodiments, a unique resource is a detected resource which has multiple instances deployed in the computing environment. For example, in an embodiment, an Amazon® auto-scaling group (ASG) includes a plurality of virtual machines, each virtual machine being an instance from a single image, code object, etc. In some embodiments, configuration data is extracted from a single virtual machine of the plurality of virtual machines, so as to decrease redundant operations in the cloud computing environment.

In an embodiment, configuration data includes an identifier of a machine type (e.g., t2_micro) which indicates specifications of a particular deployment, a processor type, a memory type, a storage type, a network interface type, an internal IP address, an external IP address, an operating system type, a combination thereof, and the like.

In an embodiment, a codifier is configured to generate a plurality of code objects. According to an embodiment, each code object is generated based on extracted configuration data, for example of a unique resource. In some embodiments, each code object includes at least a portion of extracted configuration data.

At S630, a declaration code is generated. In an embodiment, the declaration code is generated for an infrastructure as code (IaC) platform. For example, in an embodiment, the declaration code is generated as a Terraform® file which includes therein a plurality of code objects, each code object generated based on configuration data extracted from a respective resource deployed in the primary computing environment.

In some embodiments, a plurality of declaration codes are generated. In certain embodiments, each declaration code includes a timestamp, and is associated with a specific recovery point. In an embodiment, a primary computing environment includes a plurality of sub-environments, each sub-environment having its own declaratory code. In such embodiments, each sub-environment includes its own recovery points, and recovery can be initiated for only a portion of the cloud computing environment, e.g., based on a selected sub-environment. For example, in an embodiment, a primary computing environment includes a plurality of VPCs, each VPC having its own recovery points.

According to an embodiment, a predetermined number of declaratory codes, each corresponding to a recovery point, are stored, such that there are no more than the predetermined number of recovery points. In an embodiment, when a new recovery point is generated (i.e., a declaratory code is generated at a current time), an old recovery point (e.g., the oldest recovery point) is deleted.

At S640, a request is received to initiate disaster recovery. In an embodiment, the request includes an authentication token. In some embodiments, the authentication token is utilized to authenticate the disaster recover request, such that the initiation of recovery is only performed in response to authenticating the request.

In some embodiments, the request is received in response to detecting a software break, a misconfiguration, a cyber attack, a breach, a crash, and the like. In an embodiment, the request includes a parameter which indicates which recovery point is selected. In some embodiments, the request includes a plurality of parameters. A parameter indicates, according to an embodiment, an identifier of a recovery point, an identifier of a recovery point of a sub-environment, a location into which recovery should be performed, an identifier of a secondary cloud computing environment, a combination thereof, and the like.

At S650, a secondary cloud computing environment is deployed. In an embodiment, the secondary cloud computing environment is deployed based on a declaratory code, and in response to receiving the request to initiated disaster recovery.

In some embodiments, deploying a secondary cloud computing environment includes configuring an orchestrator, an IaC platform, a combination thereof, and the like, to deploy resources in a secondary cloud computing environment. In an embodiment, deploying a secondary cloud computing environment includes provisioning processing circuitries, memory devices, storage devices, network interfaces, a combination thereof, and the like.

In an embodiment, a plurality of resources are deployed in the secondary cloud computing environment. In some embodiments, each resource of the plurality of resources is deployed based on a code object in the declaratory code associated with a selected restoration point.

In certain embodiments, a first portion of resources are deployed based on a declaratory code associated with a first selected restoration point, and a second portion of resources are deployed based on a declaratory code associated with a second selected restoration point.

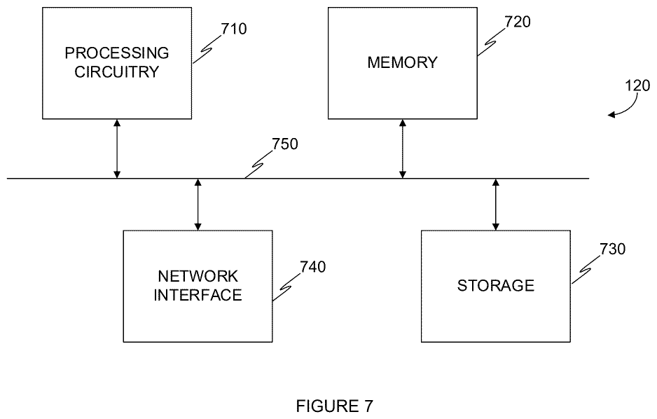

FIG. 7 is an example schematic diagram of a codifier 150 according to an embodiment. The codifier 150 includes a processing circuitry 750 coupled to a memory 720, a storage 730, and a network interface 740. In an embodiment, the components of the codifier 150 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (e.g., random access memory, etc.), non-volatile (e.g., a read-only memory, flash memory, etc.), or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 740 allows the codifier 150 to communicate with, for example, the API 140, the IaC 170, resources in the cloud computing environments, the code repository 160, and the like.

It should be understood that the embodiments described herein are not limited to the specific architecture illustrated in FIG. 7, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for disaster recovery of a cloud computing environment utilizing infrastructure as code (IaC), comprising:
accessing a primary cloud computing environment to detect resources deployed therein;
extracting configuration data from each detected resource;
generating a plurality of code objects, each code object based on extracted configuration data of a detected resource;
generating a declaration code for an Infrastructure as Code (IaC) based at least on the generated plurality of code objects;
receiving a request to initiate disaster recovery of the primary cloud computing environment; and
deploying a plurality of resources in a secondary cloud computing environment based on the generated declaration code, in response to authenticating the request to initiate disaster recovery.

2. The method of claim 1, further comprising:
accessing a plurality of sub-environments of the primary cloud computing environment; and
generating for each sub-environment a declaration code based at least on code objects generated on resources of the sub-environment.

3. The method of claim 1, further comprising:
generating a plurality of declaration codes, each declaration code associated with a restoration point including code objects generated at a defined point in time.

4. The method of claim 1, further comprising:
accessing a second plurality of code objects located in a code repository;
generating the declaration code based further on the second plurality of code objects, wherein the second plurality of code objects are integrated into the declaration code and located in a IaC configuration file.

5. The method of claim 1, further comprising:
detecting a resource deployed in the secondary cloud computing environment; and
deprovisioning a corresponding resource in the primary cloud computing environment in response to detecting the deployed resource in the secondary cloud computing environment.

6. The method of claim 5, wherein the code object from which the resource is deployed in the secondary cloud computing environment is generated based on configuration data extracted from the corresponding resource in the primary cloud computing environment.

7. The method of claim 1, further comprising:
storing the generated declaration code with an associated recovery point identifier.

8. A non-transitory computer-readable medium storing a set of instructions for disaster recovery of a cloud computing environment utilizing infrastructure as code (IaC), the set of instructions comprising:
one or more instructions that, when executed by one or more processing circuitries of a device, cause the device to:
access a primary cloud computing environment to detect resources deployed therein;
extract configuration data from each detected resource;
generate a plurality of code objects, each code object based on extracted configuration data of a detected resource;
generate a declaration code for an Infrastructure as Code (IaC) based at least on the generated plurality of code objects;
receive a request to initiate disaster recovery of the primary cloud computing environment; and
deploy a plurality of resources in a secondary cloud computing environment based on the generated declaration code, in response to authenticating the request to initiate disaster recovery.

9. A system for disaster recovery of a cloud computing environment utilizing infrastructure as code (IaC) comprising:
one or more processing circuitries configured to:
access a primary cloud computing environment to detect resources deployed therein;
extract configuration data from each detected resource;
generate a plurality of code objects, each code object based on extracted configuration data of a detected resource;
generate a declaration code for an Infrastructure as Code (IaC) based at least on the generated plurality of code objects;
receive a request to initiate disaster recovery of the primary cloud computing environment; and
deploy a plurality of resources in a secondary cloud computing environment based on the generated declaration code, in response to authenticating the request to initiate disaster recovery.

10. The system of claim 9, wherein the one or more processing circuitries are further configured to:
access a plurality of sub-environments of the primary cloud computing environment; and
generate for each sub-environment a declaration code based at least on code objects generated on resources of the sub-environment.

11. The system of claim 9, wherein the one or more processing circuitries are further configured to:
generate a plurality of declaration codes, each declaration code associated with a restoration point including code objects generated at a defined point in time.

12. The system of claim 9, wherein the one or more processing circuitries are further configured to:
access a second plurality of code objects located in a code repository; and
generate the declaration code based further on the second plurality of code objects, wherein the second plurality of code objects are integrated into the declaration code and located in a IaC configuration file.

13. The system of claim 9, wherein the one or more processing circuitries are further configured to:
detect a resource deployed in the secondary cloud computing environment; and
deprovision a corresponding resource in the primary cloud computing environment in response to detecting the deployed resource in the secondary cloud computing environment.

14. The system of claim 13, wherein the code object from which the resource is deployed in the secondary cloud computing environment is generated based on configuration data extracted from the corresponding resource in the primary cloud computing environment.

15. The system of claim 9, wherein the one or more processing circuitries are further configured to:
store the generated declaration code with an associated recovery point identifier; and
store the generated declaration code with an associated recovery point identifier.
